(19) United States
(12) Patent Application Publication
(10) Pub. No.: US 2005/0149215 A1
(43) Pub. Date: Jul. 7, 2005

(54) Universal plug and play remote audio mixer

(76) Inventor: Sachin Deshpande, Vancouver, WA (US)

Correspondence Address: MARGER JOHNSON & MCCOLLOM, P.C. - SHARP, 1030 SW MORRISON STREET, PORTLAND, OR, 97205, US

(21) Appl. No.: 10/970,407

(22) Filed: Oct. 20, 2004

Related U.S. Application Data
(60) Provisional application No. 60/535,126, filed on Jan. 6, 2004.

(51) Int. Cl. G06F 17/00

(52) U.S. Cl. 700/94; 381/77

(57) ABSTRACT

A control point remotely queries and adjusts settings for multiple remote audio sources including audio input and audio output sources using standardized command messages. In one example, the command messages use Universal Plug and Play (UPnP) actions that are interpreted by a Remote Audio Device Control (RCAUD) service operating in a remote device connected to the audio sources. A control and user interface allows an operator or user to view and control the remote audio source using the standardized command messages.

### BACKGROUND OF THE INVENTION

This application claims priority from provisional patent application Ser. No. 60/535,126, filed Jan. 6, 2004.

1. Technical Field

This technology relates to control of remote devices, and, more specifically, to a universal plug and play remote audio mixer.

2. Description of the Related Art

Currently there exist scenarios where a person would like to converse with someone or something who is communicating over a remote audio device. For example, in many cities, homeowners have entry phones installed at apartment entrances. Visitors to the apartment can select a particular phone or dial a particular number from a phone list to speak to an apartment owner.

The entry phone typically includes a microphone (audio input device) and an earpiece or a speaker (audio output device). While speaking over the apartment phone, one of the parties may wish to change the volume of the remote audio output source (speaker) if, for instance, the visitor mentions he or she cannot hear the apartment owner properly. Similarly, the apartment owner may want to increase the volume or sensitivity of the remote audio input source (microphone) if the visitor is speaking too softly, or reduce the volume if the visitor is speaking too loudly.

Bluetooth is a wireless protocol useful for sending data over a fairly low-speed wireless network. A Bluetooth Hands-Free Profile document, available at www.bluetooth.org, defines a procedure for a hands-free unit to inform a cell phone of its present speaker volume and microphone gain, and to allow for the cell phone to control the volume and gain. However, this feature is fairly narrowly defined and is limited to the Bluetooth protocol itself.

Microsoft's Remote Desktop Protocol (RDP), available at microsoft.com, includes an audio redirection feature. This allows a client machine to play an audio file locally while in a remote desktop session with a terminal server. The audio redirection basically plays back the audio on the local audio device by redirecting it from the remote audio device. The RDP may also be used to open a remote desktop application—for example Control Panel, “Sounds and Multimedia Properties” and then control the audio volume and other settings for the audio device on the remote desktop. The RDP works by sending the mouse and keyboard commands from the local client machine to the remote desktop and sending the remote desktop display back to the client machine. However, RDP is a Microsoft proprietary protocol, and requires a display device, a keyboard and a mouse (pointing device) at the local client side to perform actions at the remote site. Further, the RDP has no ability to select and coordinate connectivity between multiple audio input and output sources.

Universal Plug and Play (UPnP) is an architecture for pervasive peer-to-peer network connectivity of intelligent appliances, and devices of all form factors. The UPnP basic device architecture can be used for discovery, description, control, eventing and presentation. The current architecture specification is entitled “Universal Plug and Play Device Architecture, Version 1.0, 08 June 2000”, is available at www.upnp.org., and is incorporated herein by reference. The UPnP architecture is distinguished from a familiar moniker of “plug and play”, which is sometimes used to describe computer hardware that can be auto-detected and have software drivers automatically loaded for it.

A UPnP Rendering Control Service defines two functions, “GetVolume” and “SetVolume”, which get and set the volume state variable of a specified instance and channel to a specified value. However, this rendering control service does not define any service for a remote audio input device and it does not define a remote audio mixer service which has multiple audio input and output devices.

Embodiments of the invention address these and other limitations in the prior art.

### SUMMARY OF THE INVENTION

A control point remotely queries and adjusts settings for multiple remote audio sources using standardized command messages. In one example, the command messages use Universal Plug and Play (UPnP) actions that are interpreted by a Remote Audio Device Control (RCAUD) service operating in a remote device connected to the audio sources. A control and user interface allows an operator or user to view and control the remote audio source using the standardized command messages.

The foregoing and other features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram of a remote audio device control system.

FIG. 2 shows a particular example of the remote audio device control system that uses Universal Plug and Play (UPnP) actions. I

FIGS. 3-19 are screen shots showing how different audio control actions are implemented and verified.

FIG. 20 is a block diagram showing the different controllers and interfaces used at the control point.

FIG. 21 is a block diagram showing one example of a remote audio device control system implemented in a home network.

FIG. 22 is a detailed diagram of a television computing system used in FIG. 21.

### DETAILED DESCRIPTION

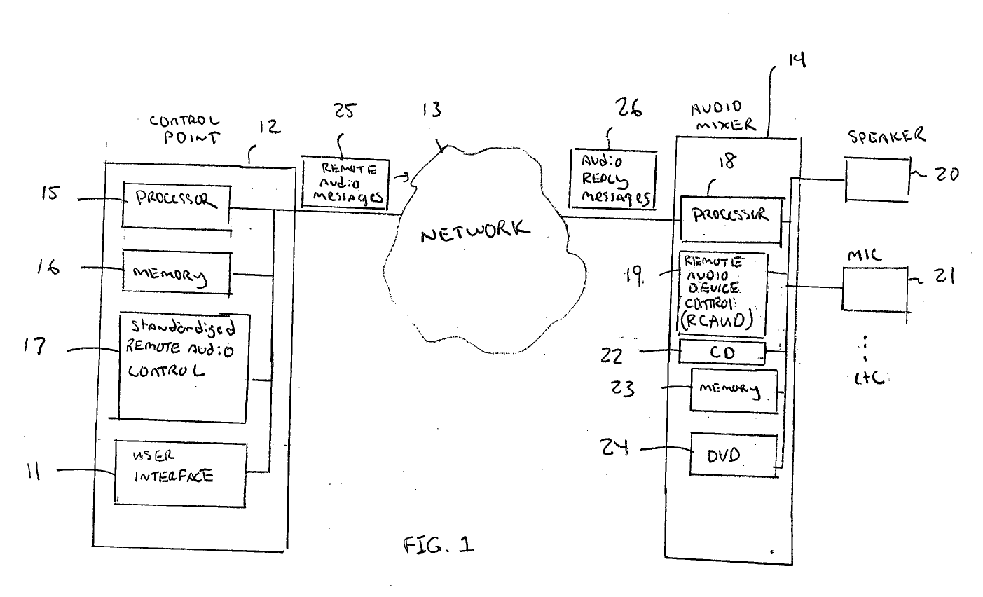

FIG. 1 shows a control point 12 connected through a network 13 to an audio mixer 14. The audio mixer 14 represents any type of device that is connected to or operates one or more audio sources. The audio mixer 14 includes a processor 18 that operates Remote Audio Device Control (RCAUD) service software 19 that controls the routing of audio lines for playing or recording from one or more audio sources. Audio output sources may include, for example, speakers 20. Audio input sources may include, for example, a microphone 20, Compact Disc (CD) player 22, MP3 files stored in memory 23, or a Digital Video Disc (DVD) player 24. Of course, any other type of audio input source or audio output source can also be used.

The control point 12 in one example is a conventional computer that includes a processor 15 and memory 16. However, the control point 12 can be any type of device that needs to communicate audio control messages remotely to audio mixer 14. For example, a Personal Computer, television computing system, Personal Digital Assistant (PDA), cellular telephone, remote control, etc.

While wired connections are shown between the network 13 and the control point 12 and audio mixer 14, the connections could alternatively be wireless connections. For example, wireless connections that use Bluetooth or the 802.11 wireless protocol. The network 13 can be any Wide Area Network (WAN) or Local Area Network (LAN) including both packet switched Internet Protocol (IP) networks and circuit switched Public Switched Telephone Networks (PSTN). In alternate embodiments the network connection may use other network technologies e.g. Infra Red, USB, Powerline etc.

The processor 15 in control point 12 operates a standardized remote audio control operation 17 that allows the control point 12 to send remote audio messages 25 over the network 13 to the audio mixer 14. The remote audio messages 25 are interpreted by the (RCAUD) service 19 and used for querying or controlling the different input and output audio sources 20-24.

After processing the remote audio messages 25, the RCAUD service 19 responds with audio reply messages 26. In one instance, the remote audio messages 25 contain subscription message for evented state variables that direct the remote audio services 19 to send back a notification message 26 when a particular audio mixer related event occurs. For example, a remote audio message 25 may ask the audio mixer service 19 to notify the control point 12 whenever an audio source is either attached or removed from the audio mixer 14.

In one embodiment, the standardized remote audio control operation 17 sends Universal Plug and Play (UPnP) messages that discover and communicate with the RCAUD service 19. The RCAUD service 19 performs UPnP actions corresponding with the UPnP messages. Of course other types of standardized protocols could also be used for sending the audio messages 25 and 26.

### EXAMPLE IMPLEMENTATION

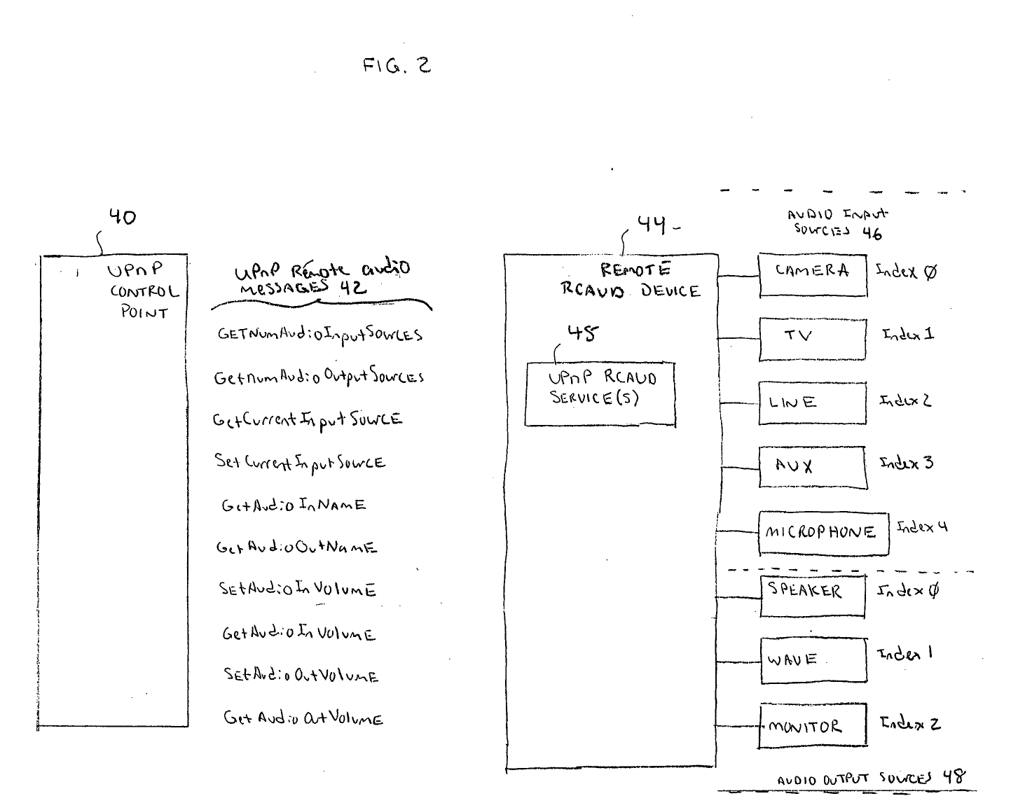

An example implementation of the UPnP Remote Audio Device Control (RCAUD) Service is shown in FIGS. 2-19. In this example, an UPnP control point 40 controls audio source functions by invoking actions on a remote UPnP device 44 that contains UPnP service(s) 45. The control point 40 discovers the remote RCAUD device 44 and RCAUD service 45 using UPnP messages 42 according to UPnP discovery mechanism.

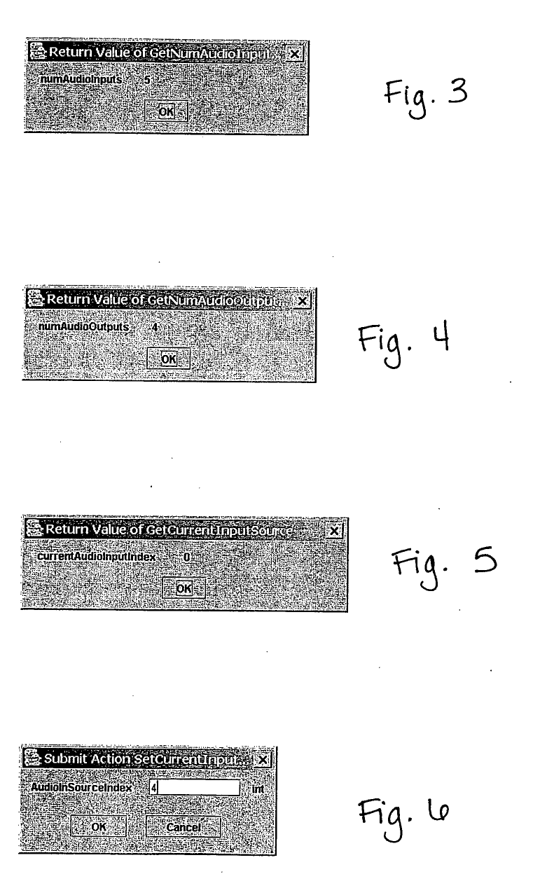

In one example, the control point 40 invokes a GetNumAudioInputSources action. The remote device 44 in this example supports five audio input sources 46 that include a camera, TV, line, aux, and microphone. However, any number of audio input sources 46 can be supported. FIG. 3 shows a display screen reporting the response to the above action. The RCAUD service 45 returns the correct number of audio input sources, 5, supported by the remote RCAUD device 44.

The control point 40 (FIG. 2) may next invoke a GetNumAudioOutputSources action. The remote RCAUD device 44 in this example supports four audio output sources 48 that include a speaker, wave, monitor, and aux. FIG. 4 shows the RCAUD service 45 returning the correct number of remote audio output sources, 4.

The control point 40 next invokes a GetCurrentInputSource action. The remote RCAUD device 44 is initially set to select the audio input source with index 0 (“Camera”). Note that in this example case the remote audio input source with index 0 is an audio video capture camera with a built-in audio input. FIG. 5 shows the RCAUD service 45 returning the index 0 of the currently selected audio input source on remote RCAUD device 44.

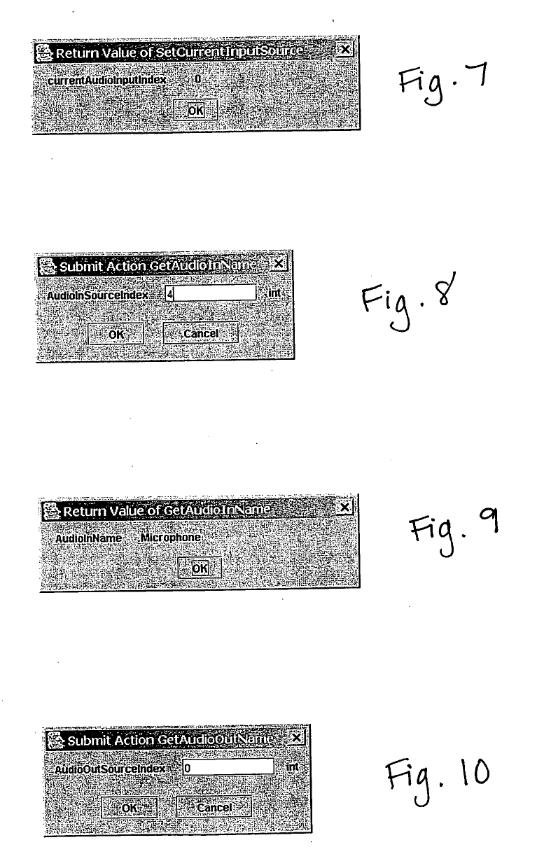

FIG. 6 shows an example screen shot from the control point 40 used for invoking a SetCurrentInputSource action that sets the remote audio input source to index 4 (“Microphone”). FIG. 7 shows the RCAUD service 45 setting the remote audio input source 46 to the requested index. In this example a return value of 0 indicates success.

FIG. 8 is a screen shot from the control point 40 invoking a GetAudioInName to find out the name of the remote audio input source 46 with index 4. FIG. 9 shows the RCAUD service 45 returning the name (“Microphone”) of the remote audio input source with index 4.

FIG. 10 is a message sent from the control point 40 invoking a GetAudioOutName to find out the name of the remote audio output source 48 with index 0. FIG. 11 shows the RCAUD service 45 returning the name (“Speaker”) for the audio output source 48 with index 0.

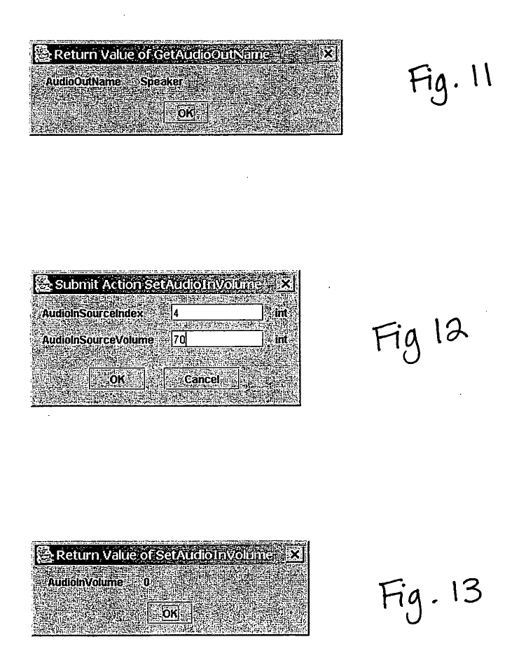

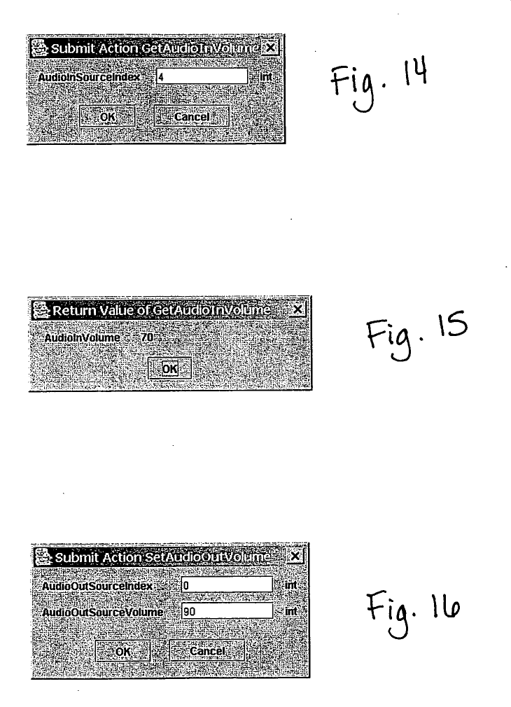

FIG. 12 is a screen shot of the control point 40 invoking a SetAudioInVolume action to set the input volume settings to 70 for the audio input source 46 with index 4 (“Microphone”). FIG. 13 shows the RCAUD service 45 setting the input volume setting for the audio input source 46 with index 4 (A return value of 0 indicates success).

FIG. 14 is a screen shot showing a UPnP message being sent from the control point 40 to invoke a GetAudioInVolume message. The GetAudioInVolume message is used for finding out the input volume settings for the input source 46 with index 4 (“Microphone”).

FIG. 15 shows the RCAUD service 45 returning the input volume setting for the input source with index 4 at the remote RCAUD device 44.

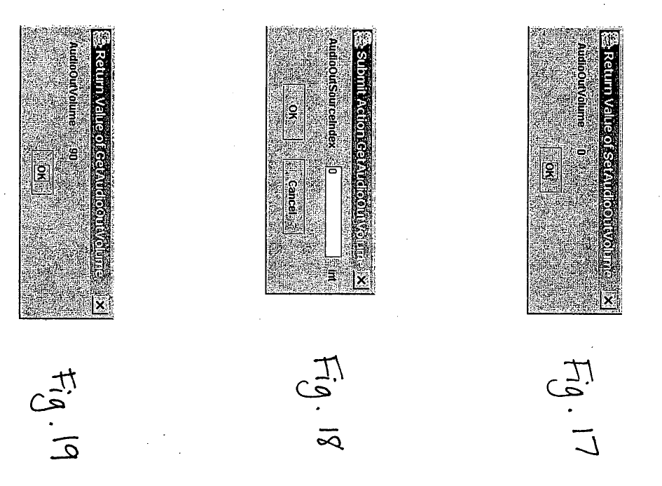

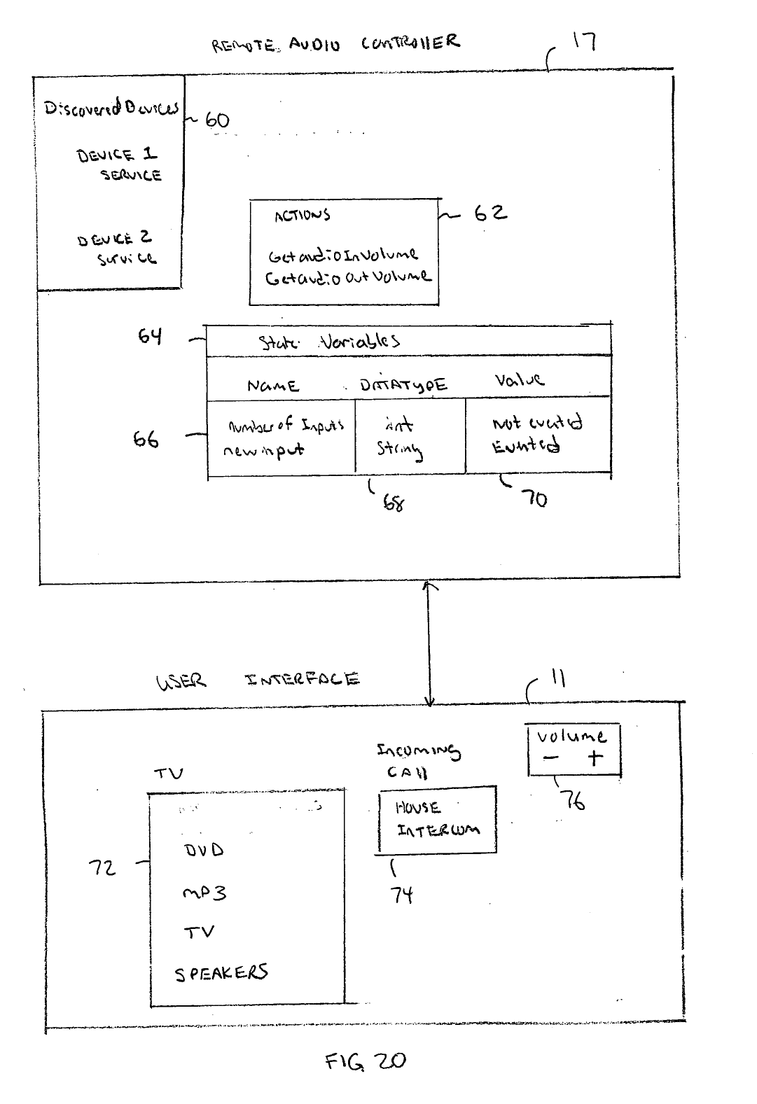

FIG. 16 illustrates the control point 40 invoking a SetAudioOutVolume message to set the output volume settings to 90 for the output source 48 with index 0 (“Speaker”). FIG. 17 shows the RCAUD service 45 setting the output volume setting for the output source 48 with index 0 (A return value of 0 indicates success).

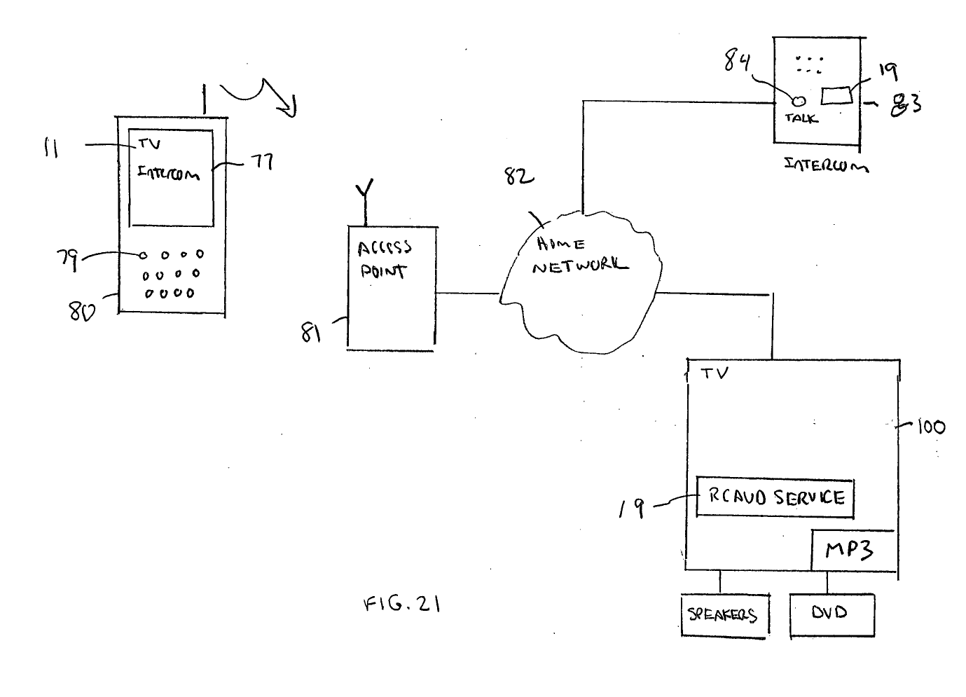

FIG. 18 showing the control point 40 invoking a GetAudioOutVolume action to find out the output volume settings for the output source 48 with index 0 (“Speaker”). FIG. 19 shows the RCAUD service 45 returning the output volume setting for the output source 48 with index 0.

Thus, the UPnP actions 42 can be used to control multiple remote input and output source settings. The RCAUD services 45 allow a control point 40 to obtain the number of remote audio input sources 46 and number of remote audio output source 48 supported by the remote RCAUD device 44. The control point 40 can also get and set the volume for remote audio input sources 46 and remote audio output sources 48. Input sources 46 or output sources 48 can also be queried and selected.

Of course, not all actions are required to be implemented and the above-listed actions can be combined with other actions and functions to produce further actions. Examples of such combined actions can include querying a mute status of a remote audio input/output source, setting the mute status of a remote audio input/output source, adjusting audio equalizer and other similar settings. One particular embodiment of the remote audio actions described above are described and implemented in Extensible Markup Language (XML) and are illustrated below in Appendix 1. In an alternative embodiment, a Simple Object Access Protocol (SOAP) is used for transporting the UPnP commands over the network.

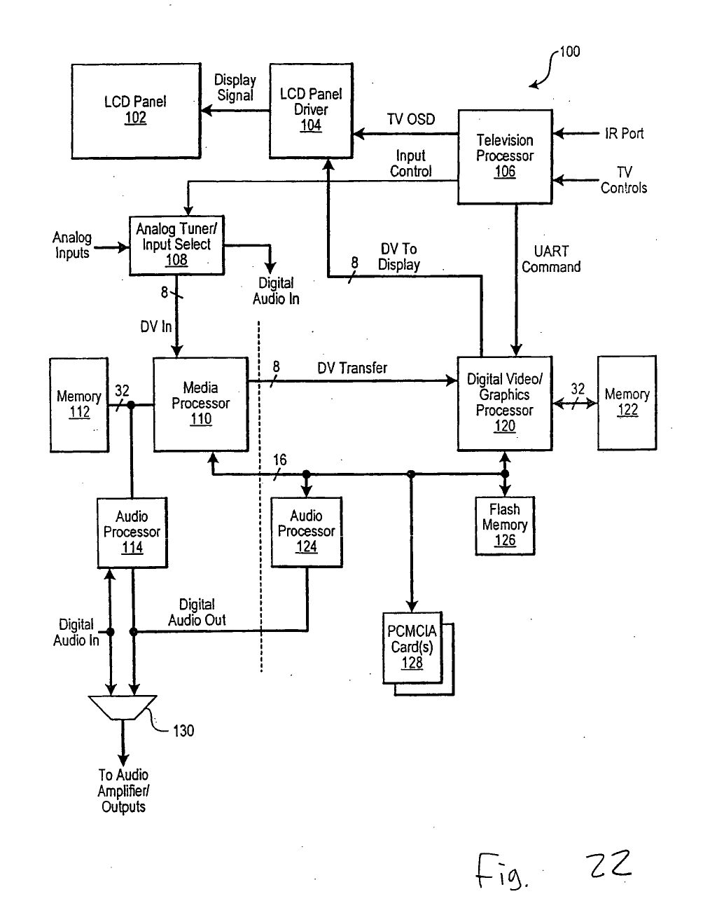

FIG. 20 shows an example of the standardized remote audio controller 17 and the user interface 11 previously shown in FIG. 1. The generic remote audio controller 17 in one example includes a UPnP interface used for configuring UPnP remote audio messages 25 (FIG. 1). In one example, the controller 17 includes a device locator 60 that identifies the different devices on the network that support RCAUD services 19. Software currently exists that can identify UPnP services on remote network devices. Therefore this operation is not described in further detail.

The controller 17 in section 62 can configure and identify the different actions that are supported in each remote RCAUD service 19 using UPnP description step. Such as the audio actions described above in FIGS. 2-19. A state variables section 64 configures and identifies the different variables that may be exposed by the RCAUD service 19. The state variables section 64 may identify for example, variable names 66, data types 68 and values 70. The state variables define and identify certain audio values, such as the number of audio output sources 48 (FIG. 2) or the volume value for an audio source (FIG. 12).

As mentioned above, the actions in section 62 may be defined as evented or not evented. The controller 17 may need to subscribe to certain evented state variables supported in the RCAUD service 19. An evented state variable for the RCAUD service 19 can send events using a UPnP eventing mechanism.

For example, the control point 12 (FIG. 1) may subscribe to an evented state variable which identifies a total number of remote audio sources supported by the RCAUD service 19 (FIG. 1). The RCAUD service 19 acknowledges the subscription and then begins to monitor for any audio sources that are connected or disconnected from the audio mixer 14 (FIG. 1). Accordingly, the RCAUD service 19 sends a notification message 26 (FIG. 1) back to the control point 12 (FIG. 1) whenever a current number of supported audio sources changes.

The user interface 11 shows one of many examples of how remote audio source status can be displayed to a user. The user interface 11 can be operated on any type of user operable device, such as a Personal Computer (PC) or laptop, television system, remote control, cellular telephone, Personal Digital Assistant (PDA), etc.

Referring to FIGS. 20 and 21, in one example, the user interface 11 is located on a remote control device 80. The remote control 80 may have a wireless interface, such as a 802.11 interface, that communicates wirelessly with an Access Point (AP) 81. The AP 81 is connected to a home network 82 that is also connected to a television computing system 100 and an intercom 83. The intercom 83 may be located outside a home entrance. The intercom 83 and the television system 100 both operate RCAUD services 19.

The user interface 11, as more clearly shown in FIG. 20, displays the remote devices on network 82 that operate RCAUD services 19. In this case, the interface 11 may first display item 72 that identifies the television 100 and different audio sources attached to television 100. For example, the television may include a TV, MP3, and DVD audio input sources and speakers as an audio output source. The user can then select any of the audio sources simply by touching the displayed items on screen 77 or via a keypad 79 on the remote control device 80.

Subsequently, someone may press a talk button 84 on the intercom 83. In accordance with a previously sent UPnP event subscription by the remote device 80, the intercom 83 may send a UPnP message notifying device 80 that a microphone in intercom 83 has been activated. The remote control device 80, may then display the incoming intercom call 74 on screen 77. The user then has the opportunity to select the intercom icon 74 and possibly vary the volume settings for the intercom microphone via volume icon 76 (FIG. 20).

Detailed Diagram of Control Point or Audio Mixer

Embodiments of the invention can operate on any properly networked device, such as a networked entertainment device such as the television system 100 in FIG. 21. A functional block diagram of such an entertainment device is illustrated in FIG. 22. FIG. 22 is a block diagram for a Liquid Crystal Display (LCD) television capable of operating according to some embodiments of the present invention. A television (TV) 100 includes an LCD panel 102 to display visual output to a viewer based on a display signal generated by an LCD panel driver 104. The LCD panel driver 104 accepts a primary digital video signal, which may be in a CCIR656 format (eight bits per pixel YC_{b}Cᵣ, in a “4:2:2” data ratio wherein two C_{b} and two Cᵣ pixels are supplied for every four luminance pixels), from a digital video/graphics processor 120.

A television processor 106 (TV processor) provides basic control functions and viewer input interfaces for the television 100. The TV processor 106 receives viewer commands, both from buttons located on the television itself (TV controls) and from a handheld remote control unit (not shown) through its IR (Infra Red) Port. Based on the viewer commands, the TV processor 106 controls an analog tuner/input select section 108, and also supplies user inputs to a digital video/graphics processor 120 over a Universal Asynchronous Receiver/Transmitter (UART) command channel. The TV processor 106 is also capable of generating basic On-Screen Display (OSD) graphics, e.g., indicating which input is selected, the current audio volume setting, etc. The TV processor 106 supplies these OSD graphics as a TV OSD signal to the LCD panel driver 104 for overlay on the display signal.

The analog tuner/input select section 108 allows the television 100 to switch between various analog (or possibly digital) inputs for both video and audio. Video inputs can include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

The analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

The media processor 110 and the digital video/graphics processor 120 (digital video processor) provide various digital feature capabilities for the television 100, as will be explained further in the specific embodiments below. In some embodiments, the processors 110 and 120 can be TMS320DM270 signal processors, available from Texas Instruments, Inc., Dallas, Tex. The digital video processor 120 functions as a master processor, and the media processor 110 functions as a slave processor. The media processor 110 supplies digital video, either corresponding to DV In or to a decoded media stream from another source, to the digital video/graphics processor 120 over a DV transfer bus.

The media processor 110 performs MPEG (Moving Picture Expert Group) coding and decoding of digital media streams for television 100, as instructed by the digital video processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by the media processor 110.

The digital video processor 120 coordinates (and/or implements) many of the digital features of the television 100. A 32-bit-wide data bus connects a memory 122, e.g., two 16-bit-wide×1M synchronous DRAM devices connected in parallel, to the processor 120. A 16-bit-wide system bus connects the digital video processor 120 to the media processor 110, an audio processor 124, flash memory 126, and removable PCMCIA cards 128. The flash memory 126 stores boot code, configuration data, executable code, and Java code for graphics applications, etc. PCMCIA cards 128 can provide extended media and/or application capability. The digital video processor 120 can pass data from the DV transfer bus to the LCD panel driver 104 as is, and/or processor 120 can also supersede, modify, or superimpose the DV Transfer signal with other content.

The multiplexer 130 provides audio output to the television amplifier and line outputs (not shown) from one of three sources. The first source is the current Digital Audio In stream from the analog tuner/input select section 108. The second and third sources are the Digital Audio Outputs of audio processors 114 and 124. These two outputs are tied to the same input of multiplexer 130, since each audio processor 114, 124, is capable of tri-stating its output when it is not selected. In some embodiments, the processors 114 and 124 can be TMS320VC5416 signal processors, available from Texas Instruments, Inc., Dallas, Tex.

As can be seen from FIG. 22, the TV 100 is broadly divided into three main parts, each controlled by a separate CPU. Of course, other architectures are possible, and FIG. 22 only illustrates an example architecture. Broadly stated, and without listing all of the particular processor functions, the television processor 106 controls the television functions, such as changing channels, changing listening volume, brightness, and contrast, etc. The media processor 110 encodes audio and video (AV) input from whatever format it is received into one used elsewhere in the TV 100. Discussion of different formats appears below. The digital video processor 120 is responsible for decoding the previously encoded AV signals, which converts them into a signal that can be used by the panel driver 104 to display on the LCD panel 102.

In addition to decoding the previously encoded signals, the digital video processor 120 is responsible for accessing the PCMCIA based media 128, as described in detail below. Other duties of the digital video processor 120 include communicating with the television processor 106, and hosting an IP protocol stack, upon which UPnP can operate. In alternate embodiments the IP protocol stack may be hosted on processor 106 or 110.

A PCMCIA card is a type of removable media card that can be connected to a personal computer, television, or other electronic device. Various card formats are defined in the PC Card standard release 8.0, by the Personal Computer Memory Card International Association, which is hereby incorporated by reference. The PCMCIA specifications define three physical sizes of PCMCIA (or PC) cards: Type I, Type II, and Type III. Additionally, cards related to PC cards include SmartMedia cards and Compact Flash cards. Type I PC cards typically include memory enhancements, such as RAM, flash memory, one-time-programming (OTP) memory and Electronically Erasable Programmable Memory (EEPROM). Type II PC cards generally include I/O functions, such as modems, LAN connections, and host communications. Type III PC cards may include rotating media (disks) or radio communication devices (wireless).

The TV system 100 can connect to an information network either through a wired or wireless connection. A wired connection could be connected to the digital video processor 120, such as a wired Ethernet port, as is known in the art. Additionally, or alternatively, the TV system 100 can connect to an information network through a wireless port, such as an 802.11b Ethernet port. Such a port can conveniently be located in one of the PCMCIA cards 128, which is connected to the media processor 110 and the digital video processor 120. Either of these processors 110, 120 could include the IP protocols and other necessary underlying layers to support a UPnP device and/or control point running on the processors 110, 120.

Additionally, the TV system 100 of FIG. 22 includes both an audio input device, such as a microphone to produce analog inputs, which may be input to the tuner 108, and an audio output device, such as the audio processors 114, 124. Functions of either of the audio input or output can be controlled by embodiments of the invention. The UPnP RCAUD service 19 can operate on any of the processors 110, 120, or even 106 of the TV system 100 of FIG. 22.

### Appendix 1

The following is an example of an XML service description for a remote audio device UPnP control. For example, the audio commands below would be sent by the remote audio controller 17 (FIG. 1). The scheme below defines a grammar for invoking remote audio actions. For example, actions are defined that have an action name. The arguments for the action are defined as input arguments or output arguments with related state variables as described above in FIG. 20.

UPnP Remote Audio Device Control Service Description XML:

```
  <?xml version=“1.0” ?>
- <scpd xmlns=“urn:schemas-upnp-org:service-1-0”>
  - <specVersion>
      <major>1</major>
      <minor>0</minor>
    </specVersion>
  - <actionList>
    - <action>
        <name>GetAudioInVolume</name>
      - <argumentList>
        - <argument>
            <name>AudioInSourceIndex</name>
              <relatedStateVariable>lastinputindex</relatedState
              Variable>
            <direction>in</direction>
          </argument>
        - <argument>
            <name>AudioInVolume</name>
              <relatedStateVariable>lastinputvolume</relatedState
              Variable>
            <direction>out</direction>
          </argument>
        </argumentList>
      </action>
    - <action>
          <name>GetAudioOutVolume</name>
      - <argumentList>
        - <argument>
            <name>AudioOutSourceIndex</name>
              <relatedStateVariable>lastoutputindex</relatedState
              Variable>
            <direction>in</direction>
          </argument>
        - <argument>
            <name>AudioOutVolume</name>
              <relatedStateVariable>lastinputvolume</relatedState
              Variable>
            <direction>out</direction>
          </argument>
        </argumentList>
      </action>
    - <action>
        <name>SetAudioInVolume</name>
      - <argumentList>
        - <argument>
            <name>AudioInSourceIndex</name>
              <relatedStateVariable>lastinputindex</relatedState
              Variable>
            <direction>in</direction>
          </argument>
        - <argument>
            <name>AudioInSourceVolume</name>
              <relatedStateVariable>lastinputvolume</relatedState
              Variable>
            <direction>in</direction>
          </argument>
        - <argument>
            <name>AudioInVolume</name>
              <relatedStateVariable>lastinputvolume</relatedState
              Variable>
            <direction>out</direction>
          </argument>
        </argumentList>
      </action>
    - <action>
        <name>SetAudioOutVolume</name>
      - <argumentList>
        - <argument>
            <name>AudioOutSourceIndex</name>
              <relatedStateVariable>lastoutputindex</relatedState
              Variable>
            <direction>in</direction>
          </argument>
        - <argument>
            <name>AudioOutSourcevolume</name>
              <relatedStateVariable>lastinputvolume</relatedState
              Variable>
            <direction>in</direction>
          </argument>
        - <argument>
            <name>AudioOutvolume</name>
              <relatedStateVariable>lastinputvolume</relatedState
              Variable>
            <direction>out</direction>
          </argument>
        </argumentList>
      </action>
    - <action>
        <name>GetAudioInName</name>
      - <argumentList>
        - <argument>
            <name>AudioInSourceIndex</name>
              <relatedStateVariable>lastinputindex</relatedState
              Variable>
            <direction>in</direction>
          </argument>
        - <argument>
            <name>AudioInName</name>
              <relatedStateVariable>lastinputname</relatedState
              Variable>
            <direction>out</direction>
          </argument>
        </argumentList>
      </action>
    - <action>
        <name>GetAudioOutName</name>
      - <argumentList>
        - <argument>
            <name>AudioOutSourceIndex</name>
              <relatedStateVariable>lastoutputindex</relatedState
              Variable>
            <direction>in</direction>
          </argument>
        - <argument>
            <name>AudioOutName</name>
              <relatedStateVariable>lastoutputname</relatedState
              Variable>
            <direction>out</direction>
          </argument>
        </argumentList>
      </action>
    - <action>
        <name>GetNumAudioInputSources</name>
      - <argumentList>
        - <argument>
            <name>numAudioInputs</name>
              <relatedStateVariable>numberofinputs</relatedState
              Variable>
            <direction>out</direction>
            <retval />
          </argument>
        </argumentList>
      </action>
    - <action>
        <name>GetNumAudioOutputSources</name>
      - <argumentList>
        - <argument>
            <name>numAudioOutputs</name>
              <relatedStateVariable>numberofoutputs</relatedState
              Variable>
            <direction>out</direction>
            <retval />
          </argument>
        </argumentList>
      </action>
    - <action>
        <name>GetCurrentInputSource</name>
      - <argumentList>
        - <argument>
            <name>currentAudioInputIndex</name>
              <relatedStateVariable>currentinputindex</relatedState
              Variable>
            <direction>out</direction>
            <retval />
          </argument>
        </argumentList>
      </action>
    - <action>
        <name>SetCurrentInputSource</name>
      - <argumentList>
        - <argument>
            <name>AudioInSourceIndex</name>
              <relatedStateVariable>currentinputindex</relatedState
                Variable>
            <direction>in</direction>
          </argument>
        - <argument>
            <name>currentAudioInputIndex</name>
              <relatedStateVariable>currentinputindex</relatedState
              Variable>
            <direction>out</direction>
          </argument>
        </argumentList>
      </action>
    </actionList>
  - <serviceStateTable>
    - <stateVariable sendEvents=“no”>
        <name>numberofinputs</name>
        <dataType>int</dataType>
        <defaultValue>0</defaultValue>
      </stateVariable>
    - <stateVariable sendEvents=“no”>
        <name>numberofoutputs</name>
        <dataType>int</dataType>
        <defaultValue>0</defaultValue>
      </stateVariable>
    - <stateVariable sendEvents=“no”>
        <name>currentinputindex</name>
        <dataType>int</dataType>
        <defaultValue>0</defaultValue>
      </stateVariable>
    - <stateVariable sendEvents=“no”>
        <name>lastinputindex</name>
        <dataType>int</dataType>
        <defaultValue>0</defaultValue>
      </stateVariable>
    - <stateVariable sendEvents=“no”>
        <name>lastoutputindex</name>
        <dataType>int</dataType>
        <defaultValue>0</defaultValue>
      </stateVariable>
    - <stateVariable sendEvents=“no”>
        <name>lastinputvolume</name>
        <dataType>int</dataType>
        <defaultValue>0</defaultValue>
      </stateVariable>
    - <stateVariable sendEvents=“no”>
        <name>lastinputvolume</name>
        <dataType>int</dataType>
        <defaultValue>0</defaultValue>
      </stateVariable>
    - <stateVariable sendEvents=“no”>
        <name>lastinputname</name>
        <dataType>string</dataType>
        <defaultValue>0</defaultValue>
      </stateVariable>
    - <stateVariable sendEvents=“no”>
        <name>lastoutputname</name>
        <dataType>string</dataType>
        <defaultValue>0<defaultValue>
      </stateVariable>
    </serviceStateTable>
  </scpd>
```

The XML code below implements one example of the UPnP remote audio device which has the RCAUD Service 19 (FIG. 1). The code below identifies a device and the type of services embedded in the device. The device may include more than one service.

```
<?xml version=“1.0” ?>
- <root xmlns=“urn:schemas-upnp-org:device-1-0”>
  - <specVersion>
      <major>1</major>
      <minor>0</minor>
    </specVersion>
      <URLBase>http://192.168.0.10:80/sharpRemoteAudioDevice
      </URLBase>
  - <device>
      <deviceType>urn:schemas-sharplabs-
        com:device:remoteaudioctrl:1</deviceType>
      <friendlyName>Sharp Remote Audio Device</friendlyName>
      <manufacturer>Sharp</manufacturer>
        <manufacturerURL>http://www.sharplabs.com
        </manufacturerURL>
      <modelDescription>A Remotely Controllable Audio
        Device</modelDescription>
      <modelName>RC V1</modelName>
      <modelNumber>0.1</modelNumber>
      <serialNumber>06032003</serialNumber>
      <UDN>uuid:sharpRemoteAudioDevice</UDN>
      <UPC>06032003</UPC>
    - <iconList>
      - <icon>
          <mimetype>image/gif</mimetype>
          <width>30</width>
          <height>30</height>
          <depth>8</depth>
          <url>rcaudicon.gif</url>
        </icon>
      </iconList>
    - <serviceList>
      - <service>
          <serviceType>urn:schemas-sharplabs-
            com:service:RCAUD:1</serviceType>
          <serviceId>urn:schemas-sharplabs-
            com:serviceId:RCAUD:1</serviceId>
          <SCPDURL>/sharpRemoteAudioDevice/urn_upnp-
            org_serviceId_RCAUD_1/description.xml</SCPDURL>
          <controlURL>/sharpRemoteAudioDevice/urn_upnp-
            org_serviceId_RCAUD_1/control</controlURL>
          <eventSubURL>/sharpRemoteAudioDevice/urn_upnp-
            org_serviceId_RCAUD_1/eventSub</eventSubURL>
        </service>
      </serviceList>
    <presentationURL>http://192.168.0.10:80/sharpRemoteAudioDevice/
      presentation.html</presentationURL>
    </device>
  </root>
```

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

1. A remote audio control system, comprising:
a control point configured to send remote audio commands over a network to a remote device operating multiple audio sources, the remote audio commands causing the remote device to control or query audio settings for the multiple audio sources.

2. The remote audio control system according to claim 1 wherein the multiple audio sources include one or more audio input sources.

3. The remote audio control system according to claim 1 wherein the multiple audio sources include one or more audio output sources.

4. The remote audio control system according to claim 1 wherein the control point uses Universal Plug and Play (UPnP) actions to control or query the audio settings.

5. The remote audio control system according to claim 1 wherein the control point uses a Universal Plug and Play (UPnP) eventing mechanism to obtain the audio settings.

6. The remote audio control system according to claim 1 including a Remote Audio Device Control (RCAUD) service operated in the remote device that carries out UPnP actions that control or query the audio settings according to the Universal Plug and Play (UPnP) actions invoked by the control point.

7. The remote audio control system according to claim 6 including an audio control interface operated on the control point that identifies remote devices operating RCAUD services and initiates actions for controlling or querying the audio settings for the remote audio sources via the RCAUD services.

8. The remote audio control system according to claim 1 including a user interface operated from the control point that displays the audio sources connected to the remote devices and allows a user to control selection and operation of the audio sources.

9. The remote audio system according to claim 1 wherein the control point uses the audio commands to query and select between multiple audio sources operating on the remote device.

10. The remote audio system according to claim 9 wherein the multiple audio sources include one or more audio input sources.

11. The remote audio system according to claim 9 wherein the multiple audio sources include one or more audio output sources.

12. The remote audio system according to claim 1 wherein the control point uses the audio commands to get and set volume for selected audio sources operated by the remote device.

13. The remote audio system according to claim 1 wherein the audio commands include evented audio state variables that allow the remote device to monitor the audio sources for a specified audio event and then send a notification message back to the control point when the specified audio event occurs.

14. The remote audio system according to claim 1 wherein the remote audio commands are sent over the network using an Extensible Markup Language (XML).

15. The remote audio system according to claim 1 wherein the remote audio commands are sent over the network using a Simple Object Access Protocol (SOAP).

16. A method for remotely controlling audio sources, comprising:
sending audio command messages across a network to a Remote Audio Device Control (RCAUD) service operating on a remote network device;
using the audio command messages to control or query audio input sources and audio output sources located on the remote network device.

17. The method according to claim 16 including using Universal Plug and Play (UPnP) actions for remotely adjusting or querying settings for the audio sources.

18. The method according to claim 16 including using a Universal Plug and Play (UPnP) eventing mechanism for remotely obtaining settings for the audio sources.

19. The method according to claim 16 including using an Extensible Markup Language (XML) for transporting the UPnP commands over the network.

20. The method according to claim 16 including using a Simple Object Access Protocol (SOAP) for transporting the UPnP commands over the network.

21. The method according to claim 16 including using the UPnP discovery messages to discover RCAUD services on different remote network devices.

22. The method according to claim 16 including using the audio command messages to retrieve a total number of available audio input sources or audio output sources on the remote network device.

23. The method according to claim 16 including using the audio command messages to enable the different audio sources.

24. The method according to claim 16 including using the audio command messages to select the different audio sources.

25. The method according to claim 16 including using the audio command messages to retrieve or vary volume setting for the audio sources.

26. The method according to claim 16 including using the audio command messages to retrieve indexes associated with the audio sources.

27. The method according to claim 16 including using the audio command messages to retrieve names associated with the audio sources.

28. The method according to claim 16 including using the audio command messages to retrieve currently selected/active audio sources.

29. The method according to claim 16 including using the audio command messages to query or adjust mute status for the audio sources.

30. The method according to claim 16 including using the audio command messages to query or adjust audio equalizer settings for the audio sources.

31. The method according to claim 16 including operating a user interface that displays remote network devices supporting RCAUD services and displays the audio sources operating in the remote network devices, the user interface allowing a user to initiate the audio command messages by selecting the displayed remote network devices and displayed audio sources.

32. The method according to claim 31 wherein the user interface automatically displays new remote network devices after being attached to the network and new audio sources after being attached to the remote network devices and automatically stops displaying any remote network devices that are removed from the network and audio sources removed from the remote network devices.

33. The method according to claim 16 including a Universal Plug and Play (UPnP) controller that identifies remote devices that operate the RCAUD services and initiates UPnP actions for controlling the audio sources.

34. A network device, comprising:
a processor operating a Remote Audio Device Control (RCAUD) service configured to control or query multiple audio sources located on the network device according to a standardized set of audio control messages received over a network.

35. The network device according to claim 34 wherein the audio control messages use Universal Plug and Play (UPnP) actions.

36. The network device according to claim 34 wherein the audio control messages use Universal Plug and Play (UPnP) event messages.

37. The network device according to claim 36 wherein the UPnP event messages are sent over the network using Extensible Markup Language (XML) instructions.

38. The network device according to claim 36 wherein the UPnP event messages are sent over the network using Simple Object Access Protocol (SOAP).

39. The network device according to claim 34 wherein the Remote Audio Device Control (RCAUD) service includes non-evented state variables and evented state variables that can cause the RCAUD service to send notification messages when one or more specified events associated with the audio sources occur.

40. The network device according to claim 34 wherein the audio control messages cause the RCAUD service to identify a number of audio input sources and audio output sources operating on the network device.

41. The network device according to claim 34 wherein the audio control messages cause the RCAUD service to obtain or set a volume for a selected one of the multiple audio sources.

42. The network device according to claim 34 wherein the audio control messages cause the RCAUD service to select an identified one of the multiple audio sources for controlling remotely.
